(19) United States
(12) Patent Application Publication
(10) Pub. No.: US 2026/0208719 A1
(43) Pub. Date: Jul. 23, 2026

(54) METHOD FOR CHECKING THE FUNCTIONALITY OF AN ELECTROMECHANICAL WHEEL BRAKE DEVICE OF A MOTOR VEHICLE, WHEEL BRAKE DEVICE, AND BRAKE SYSTEM

(71) Applicant: Robert Bosch GmbH, Stuttgart (DE)

(72) Inventors: Laszlo Boros, Ludwigsburg (DE); Rainer Walter, Pleidelsheim (DE); Simon Peter, Weil Der Stadt (DE); Simon Schrade, Baindt (DE); Xi Nowak, Bisingen (DE)

(21) Appl. No.: 19/134,421

(22) PCT Filed: Jun. 3, 2024
(86) PCT No.: PCT/EP2024/065205

§ 371 Date: May 30, 2025

(30) Foreign Application Priority Data
Jun. 22, 2023 (DE) 10 2023 205 887.1

(51) Int. Cl. B60T 17/22; B60T 13/74; F16D 55/226; F16D 65/18; F16D 127/06

(52) U.S. Cl. CPC B60T 17/221; B60T 13/746; F16D 65/18; B60T 2220/04; B60T 2250/04; F16D 55/226; F16D 2127/06

(57) ABSTRACT

A method for checking the functionality of an electromechanical wheel brake device of a motor vehicle. The wheel brake device has at least one first electromechanical actuator for actuating the wheel brake device and a second electromechanical actuator for blocking the wheel brake device for a parking brake function. The second actuator is activated in order to block the wheel brake device. The first actuator is activated in order to actuate the wheel brake device. A movement variable of the first actuator is detected. If the movement variable falls below a specified threshold, the second actuator is detected as being functional, otherwise the second actuator is detected as being faulty.

### FIELD

The present invention relates to a method for checking the functionality of an electromechanical wheel brake device of a motor vehicle. The wheel brake device has at least one first electromechanical actuator for actuating the wheel brake device and a second electromechanical actuator for blocking the wheel brake device for a parking brake function.

In addition, the present invention relates to an electromechanical wheel brake device as well as an electromechanical brake system with such a wheel brake device.

### BACKGROUND INFORMATION

Hydraulically actuatable wheel brake devices are known as service brakes for motor vehicles in which a parking brake mechanism is represented by a separate actuator. For example, conventional electromechanical parking brakes typically include an electric machine, an associated reduction gear, and a spindle mechanism, and which are integrated into a hydraulic brake caliper or act on drum brakes. These actuators are typically designed with self-locking gear/spindle mechanisms to ensure parking brake function even in the unpowered state of a parked vehicle after actuation.

In addition, purely electromechanically actuatable wheel brake devices are known as service brakes for motor vehicles. These also typically include an electric machine, an associated reduction gear, and a spindle mechanism. In contrast to parking brake actuators, however, the components for service brakes do not have to be designed to be self-locking so that, in the event of a failure such as a power supply failure, the brake will open during operation so as not to jeopardize the travel stability of the motor vehicle. One conventional way to integrate a parking brake mechanism into such non-self-locking electromechanical service brakes is by using a second actuator that may block the service brake mechanism when in the closed state. For example, form-locking catch mechanism is used, which may block the motor pinion of the service brake. This mechanism ensures that the service brake may be blocked such that it remains closed in the unpowered parked state of the motor vehicle and allows for safe parking. The structural difference of such parking brake mechanisms compared to the aforementioned actuator combinations (hydraulically actuatable service brake and electromechanical parking brake) is that application of the parking brake torque does not occur independently of applying the service brake torque.

Furthermore, various function checks and plausibility checks of the brake actuators for service and parking brakes are described in the related art, since their correct operation is critical for safety. For example, in driving situations where the driver is not able to actively intervene in cases of failure, a correct functioning of the parking brake is particularly critical for safety. This is the case, for example, with remote-controlled parking (RCP). In this case, for example, prior to remotely parking, the operation of the parking brake actuator may be checked to ensure that it may be properly engaged after parking. For example, in the case of conventional electromechanical parking brake actuators used in combination with hydraulically actuatable service brakes, the power consumption may be checked for plausibility and/or the movement of the actuator may be detected while building up clamping force.

### SUMMARY

In a method according to an example embodiment of the present invention, the second actuator is activated in order to block the wheel brake device, the first actuator is activated in order to actuate the wheel brake device, a movement variable of the first actuator is detected, and if the movement variable falls below a specified threshold, the second actuator is detected as being functional, otherwise the second actuator is detected as being faulty. This ensures a particularly advantageously simple and reliable check of the second actuator acting as a parking brake actuator. The test is preferably performed in the open state of the brake so that no braking torque is produced during the test activation. As a result, the test may advantageously be performed unnoticed by a driver even during (slow) travel. The test procedure is advantageously performed very quickly, and a realistic load case is simulated for the parking brake actuator. The verification of the second actuator as a parking brake actuator is further advantageously based on the independent first actuator as a service brake actuator. In this respect, control and sensory systems used for testing are independent of the parking brake actuator itself. This advantageously detects mechanical failures, for example, jamming or damage, and electrical faults in the parking brake mechanism. As described above, the method according to the present invention thus provides an advantageous operating strategy for checking the functionality of the parking brake actuator for motor vehicles with electromechanical service brakes. In particular, the second actuator is configured to block the first actuator, for example, as described at the outset, as an actuator of a locking catch in a gear mechanism. Thus, the possibility of a functional check described at the outset, with checking the power consumption for plausibility and/or detecting movement of the actuator while building up clamping force, is eliminated, because the braking torque itself is always built up by the first actuator as a service brake actuator and not by a separate parking brake actuator. The correct buildup of the braking torque could be checked if the motor vehicle remains at a standstill on an incline or if it remains at a standstill despite driving torque. This requires at least the following method steps: clamping the brakes by means of the service brake, applying the parking brake, turning off power to the service brake, if indicated building up driving torque, and determining the braking torque. Such a method leads to a time-consuming test routine, which cannot go unnoticed by a driver and may, therefore, be perceived as uncomfortable. The operating strategy according to an example embodiment of the present invention, on the other hand, has the advantage that the second actuator is checked for functionality as part of the parking brake mechanism without this being noticed by the driver, which is beneficial to the driver's comfort. This test activation is preferably applied before situations occur in which proper operation of the parking brake is particularly critical for safety, for example, prior to remote-controlled parking. The method according to the present invention may be used for all electromechanical service brakes with an integrated parking brake mechanism, in which the actuator responsible for the parking brake mechanism blocks the wheel brake device, in particular the service brake. For example, this relates to wheel brake devices in which a pin blocks a pinion of a motor shaft of the first actuator of the service brake. The pin is in particular engaged via a second actuator configured as a coil or linear motor. Preferably, the pin is engaged, i.e., the parking brake mechanism is actuated, and the first actuator is subsequently activated to set a torque, which in particular corresponds to a reset torque of the brake at a maximum clamping force required for parking. If the motor shaft does not move or only moves slightly, the parking brake is correctly engaged. In parking brake mechanisms, in which a gear of the first actuator is secured against reverse rotation during parking operation by means of a freewheel that is controllable by the second actuator, the procedure is analogous. In addition, form-locking/friction-locking parking brake mechanisms, for example having a friction brake device acting on a motor pinion of the first actuator, which brake device may be activated by the second actuator, may be checked analogously. Preferably, prior to carrying out the method according to the present invention, the first actuator is checked for its functionality, in particular as a prior method step. In particular, the test according to the present invention is carried out on every wheel of the motor vehicle, which has a corresponding actuator with a parking function, for example, when unlocking the motor vehicle and/or when driving away. In particular, testing is carried out in parallel on all corresponding wheel brake devices. Since the design of the actuators usually ensures that additional clamping of the service brake by the first actuator is always possible, the test is preferably also carried out simultaneously during travel. Otherwise, each wheel brake device is preferably tested individually or each wheel is tested in succession.

According to a preferred further development of the present invention, it is provided that the second actuator is activated in order to block a rotation of a rotor shaft of the first actuator and that a change of a rotor position of the rotor shaft is detected as a movement variable. A particularly advantageous possibility for testing the functionality of the second actuator is thus created if the first actuator is configured as a rotational actuator, in particular an electrical rotational drive. For example, a rotor position is measured via a rotor position sensor of the actuator configured as an electric machine. If this position remains unchanged or at least below a specified threshold, the parking brake mechanism is correctly engaged.

Particularly preferably, it is provided that the second actuator is activated in order to block a translational displacement of a component, in particular a rotor, of the first actuator, and that a change in a displacement path of the component is detected as a movement variable. A particularly advantageous possibility for testing the functionality of the second actuator is thus created if the first actuator is configured as a linear actuator, in particular an electrical linear drive.

According to a preferred further development of the present invention, it is provided that the second actuator is activated in order to displace a locking element, in particular a catch, in such a way that the locking element cooperates with a counterpart element, in particular a pinion, arranged at or on the rotor shaft or component, in form-locking and/or force-locking manner. With such a configuration and control, the advantages of the method according to the present invention are particularly pronounced. In particular, blocking occurs by form-locking or friction-locking.

Particularly preferably, according to an example embodiment of the present invention, it is provided that a mechanical stiffness, in particular free play, of at least one of the actuators is determined as a function of the detected movement variable. This results in the advantage that, in addition to the functional capability, a further characteristic is determined in a particularly simple manner without supplemental control or measurement.

According to a preferred further development of the present invention, it is provided that, when the second actuator is activated, the first actuator is activated to actuate in the clamping direction of a brake pad of the wheel brake device. The two actuators are thus actuated simultaneously, or an advantageous overlapping of the corresponding movements is achieved. In this instance, the parking brake mechanism is engaged during a, preferably very slow, actuation of the service brake, so that an effect of the second actuator, in particular a latching into a catch as described above, is reliably identified due to the dynamic behavior observed during the clamping movement.

According to an example embodiment of the present invention, particularly preferably, it is provided that the first actuator is activated in order to actuate in the release direction of a brake pad of the wheel brake device. This results in the advantage that the movement variable is particularly precisely detected, in particular even if the wheel brake device has already been fully actuated. Preferably, the actuator is activated, in particular, a specified electric activation current is applied to it, such that a force and/or a torque of a similar order of magnitude and direction is generated as it acts as a resetting torque on the parking brake with the second actuator in a state of maximum clamping force, i.e., with maximum actuation of the wheel brake device.

According to a preferred further development of the present invention, it is provided that a travel speed of the motor vehicle is detected and that the method is performed only if the travel speed is below a specified threshold. This advantageously ensures that, in the event of a malfunction, the effects on driving safety are minimized.

It is particularly preferred, according to an example embodiment of the present invention, that the motor vehicle is monitored for a braking request and that the method is performed only if no braking request is detected. This results in the advantage that a braking operation performed simultaneously, which is usually possible as described above, does not affect the duration and result of the test.

According to a preferred further development of the present invention, it is provided that the motor vehicle is monitored for a planned, in particular autonomous, parking operation and that, if a planned parking operation is detected, the method is performed. This advantageously ensures that the functionality is determined before the next planned use of the second actuator.

According to an example embodiment of the present invention, the method is in particular coordinated with the planned parking operation so that it is completed before the parking operation begins, but at least before the motor vehicle is in the parked position.

According to an example embodiment of the present invention, it is particularly preferred that the motor vehicle is monitored for a start of travel, in particular after a parking operation performed using the second actuator, and that, when a start of travel is detected, the method is performed. This provides the advantage that the functionality is checked regularly each time when starting travel.

According to a preferred further development of the present invention, it is provided that a vehicle door of the motor vehicle is monitored for an unlocking operation and that, if an unlocking operation is detected, the method is performed. This advantageously ensures that the functionality is checked regularly, in particular before or at the time of the start of travel, because an unlocking operation is usually followed by a start of travel after a certain time delay. If it is assumed that the time delay is sufficient to perform the method, it is preferably carried out before the actual start of travel.

According to an example embodiment of the present invention, the electromechanical wheel brake device comprises at least a first electromechanical actuator for actuating the wheel brake device and a second electromechanical actuator for blocking the wheel brake device for a parking brake function. It includes a control device, which is specifically designed to perform the method according to the present invention. This results in the aforementioned advantages. The control device is in particular configured as a central control device, for example situated in a motor vehicle, or is individually associated with a wheel brake device. Preferably, the wheel brake device comprises a brake caliper comprising at least one brake pad and a brake disc, wherein at least the first actuator is coupled to the brake pad. In particular, at least one of the actuators is configured as an electric machine.

According to an example embodiment of the present invention, the electromechanical brake system includes at least one wheel brake device, in particular a wheel brake device according to the present invention that may be associated with or is associated with another wheel of a motor vehicle. This, too, results in the aforementioned advantages. In particular, the brake system is hydraulic-free, i.e., it comprises only electromechanically actuatable or actuated components.

Further preferred features and combinations of features result from the above descriptions and from the rest of the disclosure herein. The present invention will be explained in more detail in the following sections with reference to the figures.

### BRIEF DESCRIPTION OF THE DRAWINGS

FIGS. 1A and 1B show a wheel brake device, according to an example embodiment of the present invention.

FIG. 2 shows a method for operating the wheel brake device, according to an example embodiment of the present invention.

### DETAILED DESCRIPTION OF EXAMPLE EMBODIMENTS

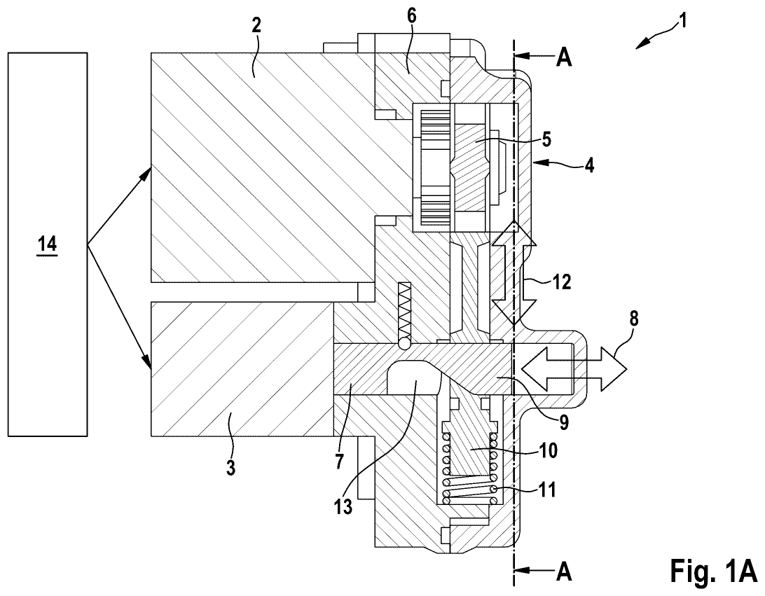

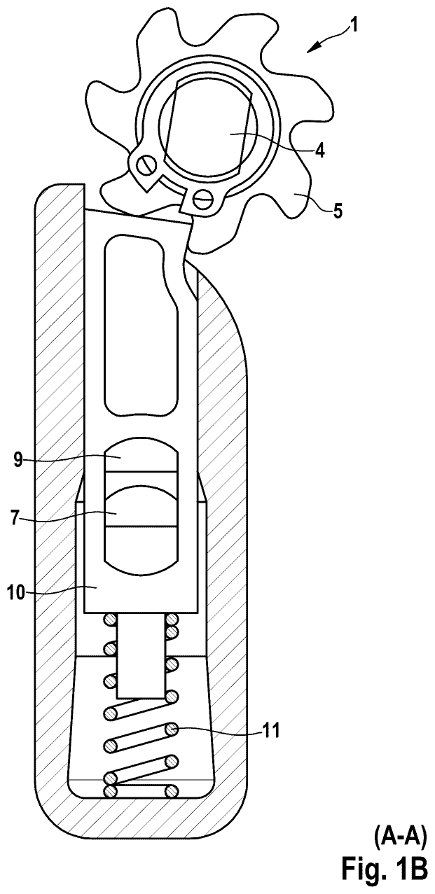

FIGS. 1A and 1B show, only schematically, views of components of a conventional wheel brake device 1 for a not further illustrated electromechanical brake system of a motor vehicle.

FIG. 1A shows a first sectional view, and FIG. 1B shows a second sectional view in the plane A-A drawn in FIG. 1A. The wheel brake device 1 comprises at least one first electromechanical actuator 2 for actuating the wheel brake device 1 and a second electromechanical actuator 3 for blocking the wheel brake device 1 for a parking brake function. In the present case, the actuators 2, 3 are each configured as an electric machine.

In the present case, the first actuator 2 is configured as a rotational actuator and comprises a rotor shaft 4 on which a gear configured as a pinion 5 is arranged in a rotationally fixed manner. The pinion 5 is in particular part of a gear arrangement 6 for actuating the wheel brake device 1. The wheel brake device 1 in particular comprises a brake caliper (not shown) with at least one brake disc and a brake pad, wherein the actuator 2 is coupled to the brake pad via the gear arrangement 6 to displace the brake pad in the direction of the brake disc and generate a braking torque.

In the present case, the second actuator 3 is configured as a linear actuator and is configured to linearly displace a first locking element 7, as indicated by a first double arrow 8. The locking element 7 partially inserts into an opening 9 of a second locking element 10 configured as a catch. The locking element 10 may be linearly displaced in the direction of the pinion 5, as a counterpart element associated with it, against the spring force of a spring element 11, as indicated by a second double arrow 12.

The first locking element 7 comprises a recess 13, the geometry of which is selected such that, when the locking element 7 is displaced in the direction of the second actuator 3 by corresponding activation of the second actuator 3, the locking element 10 with one end abuts the pinion 5 and the pinion is blocked in a form-locking manner in one rotational direction, as may be seen in FIG. 1B. In the other rotational direction, freewheeling is ensured by the particular arrangement and geometric configuration.

Finally, the actuators 2, 3 are also associated with a control device 14, which is configured to activate the actuators 2, 3.

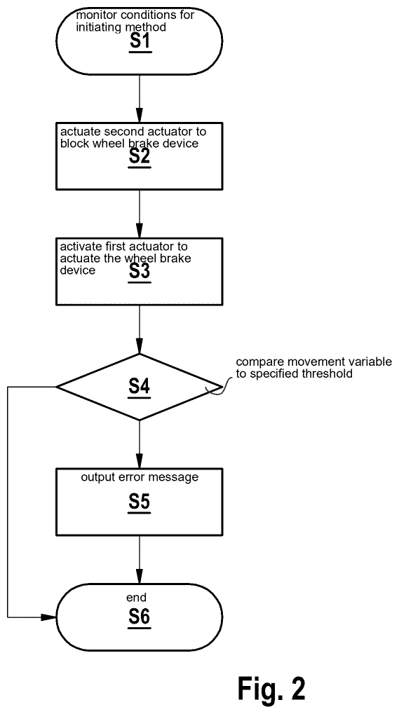

An advantageous method for operating the wheel brake device 1 is described below with reference to FIG. 2. FIG. 2 shows the method using a flow chart. In particular, the method ensures that the functionality of the actuator system, in particular the parking brake mechanism, is tested. The method is preferably carried out using the control device 14.

As described above, the method is advantageously transferred to similar wheel brake devices with the corresponding functional relationships if in the wheel brake device, in particular, a parking brake actuator is configured to block the wheel brake device, for example its service brake actuator.

In a step S1, the method begins with monitoring one or more conditions for initiating the method. Preferably, a travel speed of the motor vehicle is detected and the method is performed only if the travel speed is below a specified threshold. Alternatively or additionally, the motor vehicle is monitored for a braking request, and the method is performed only if no braking request is detected.

Particularly preferably, the motor vehicle is monitored for a planned, in particular autonomous, parking operation and, if a planned parking operation is detected, the method is performed. Alternatively or additionally, the motor vehicle is monitored for a start of travel, in particular after a parking operation performed using the second actuator 3, and, if a start of travel is detected, the method is performed. Again alternatively or additionally, a vehicle door of the motor vehicle is monitored for an unlocking operation, and, if an unlocking operation is detected, the method is performed.

Once the corresponding condition or conditions have been satisfied, the method is continued with a step S2. In step S2, the second actuator 3 is activated in order to block the wheel brake device 1. Preferably, when the second actuator 3 is activated, the first actuator 2 is activated to actuate in the clamping direction of a brake pad of the wheel brake device 1.

With respect to the wheel brake device 1 shown in FIGS. 1A and 1B, the second actuator 3 is activated to block a rotation of the rotor shaft 4 of the first actuator 2 by displacing the locking elements 7, 10 accordingly, as described above.

Alternatively, the second actuator 3 is activated in order to block a translational displacement of a component, in particular a rotor, of the first actuator 2.

In particular, the second actuator 3 is activated in order to displace a locking element, in the illustrated exemplary embodiment the locking elements 7 and 10, such that the locking element, in the illustrated exemplary embodiment the locking element 10, interacts with a counterpart element arranged at or on the rotor shaft or the component, in the illustrated exemplary embodiment with the pinion 5, in a form-locking and/or force-locking manner.

In a subsequent step S3, the first actuator 2 is activated in order to actuate the wheel brake device 1. Particularly preferably, the first actuator 2 is activated in order to actuate in the release direction of a brake pad of the wheel brake device 1. A movement variable of the first actuator 1 is in this instance detected.

With respect to the wheel brake device 1 shown in FIGS. 1A and 1B, a change in a rotor position of the rotor shaft 4 is detected as a movement variable. Alternatively, a change in a displacement path of the component is detected as a movement variable. In particular, a mechanical stiffness, in particular free play, of at least one of the actuators 2, 3 is determined as a function of the detected movement variable.

In a step S4, the movement variable is compared to a specified threshold. The threshold is in particular zero, or corresponds to an expected free play, for example, of at least one of the actuators 2, 3. If the movement variable falls below the specified threshold or reaches it at the maximum, the second actuator 3 is detected as being functional. The method ends with step S6. If the movement variable exceeds the specified threshold, the second actuator is detected as being faulty. The method is then continued with step S5.

In step S5, an error message is output, in particular on a display device that may be associated with or is associated with a driver of the motor vehicle, and/or through a wireless communication link to a computer device so that corresponding countermeasures may be taken. The method ends with the step S6.

1-14. (canceled)

15. A method for checking functionality of an electromechanical wheel brake device of a motor vehicle, wherein the wheel brake device includes at least one first electromechanical actuator for actuating the wheel brake device and a second electromechanical actuator for blocking the wheel brake device for a parking brake function, the method comprising the following steps:
activating the second actuator to block the wheel brake device;
activating the first actuator to actuate the wheel brake device;
detecting a movement variable of the first actuator; and
based on the movement variable falling below a specified threshold, detecting the second actuator as being functional, and otherwise detecting the second actuator as being faulty.

16. The method according to claim 15, wherein the second actuator is activated to block a rotation of a rotor shaft of the first actuator, and a change of a rotor position of the rotor shaft is detected as the movement variable.

17. The method according to claim 15, wherein the second actuator is activated to block a translational displacement of a component including a rotor of the first actuator, and a change in a displacement path of the component is detected as the movement variable.

18. The method according to claim 17, wherein the second actuator is activated in order to displace a locking element including a catch such that the locking element interacts with a counterpart element including a pinion, arranged at on the rotor shaft or the component, in a form-locking and/or force-locking manner.

19. The method according to claim 16, wherein a mechanical stiffness of at least one of the first and second actuators, is determined as a function of the detected movement variable.

20. The method according to claim 15, wherein when the second actuator is activated, the first actuator is activated in order to actuate in a clamping direction of a brake pad of the wheel brake device.

21. The method according to claim 15, wherein the first actuator is activated in order to actuate in a release direction of a brake pad of the wheel brake device.

22. The method according to claim 15, wherein a travel speed of the motor vehicle is detected and the method is performed only when the travel speed is below a specified threshold.

23. The method according to claim 15, wherein the motor vehicle is monitored for a braking request, and the method is performed only when no braking request is detected.

24. The method according to claim 15, wherein the motor vehicle is monitored for a planned, autonomous, parking operation, and when the planned parking operation is detected, the method is performed.

25. The method according to claim 15, wherein the motor vehicle is monitored for a start of travel after a parking operation performed using the second actuator, and when the start of travel is detected, the method is performed.

26. The method according to claim 15, wherein a vehicle door of the motor vehicle is monitored for an unlocking operation, and when the unlocking operation is detected, the method is performed.

27. An electromechanical wheel brake device, comprising:
at least one first electromechanical actuator configured to actuate the wheel brake device;
a second electromechanical actuator configured to block the wheel brake device for a parking brake function; and
a control device configured to check functionality of the wheel brake device, the control device configured to:
activate the second actuator to block the wheel brake device;
activate the first actuator to actuate the wheel brake device;
detect a movement variable of the first actuator; and
based on the movement variable falling below a specified threshold, detect the second actuator as being functional, and otherwise detect the second actuator as being faulty.

28. An electromechanical brake system of a motor vehicle, comprising:
an electromechanical wheel brake device, including:
at least one first electromechanical actuator configured to actuate the wheel brake device,
a second electromechanical actuator configured to block the wheel brake device for a parking brake function, and
a control device configured to check functionality of the wheel brake device, the control device configured to:
activate the second actuator to block the wheel brake device,
activate the first actuator to actuate the wheel brake device,
detect a movement variable of the first actuator; and
based on the movement variable falling below a specified threshold, detect the second actuator as being functional, and otherwise detect the second actuator as being faulty;
wherein the wheel brake device is associated with another wheel of the motor vehicle.
